(19) United States
(12) Patent Application Publication
(10) Pub. No.: US 2009/0189716 A1
(43) Pub. Date: Jul. 30, 2009

(54) FILTER DEVICE WITH FINITE TRANSMISSION ZEROS

(75) Inventors: Hsin-Chia Lu, Taipei (TW); Tian-Wei Huang, Taipei (TW); Chih-Chao Chang, Taipei (TW); Jia-Wei Cheng, Taipei (TW); Chien-Hsien Lee, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: NATIONAL TAIWAN UNIVERSITY, Taipei (TW)

(21) Appl. No.: 12/165,341

(22) Filed: Jun. 30, 2008

(30) Foreign Application Priority Data
Jan. 25, 2008 (TW) 097102788

(51) Int. Cl. H01P 1/203

(52) U.S. Cl. 333/204; 333/219

(57) ABSTRACT

A filter device with transmission zeros is provided according to the present invention, which has an odd mode resonant frequency and an even mode resonant frequency. The filter device includes: a substrate, a metallic rectangular ring, a signal couple-in/couple-out module, and a metallic ground plane, wherein the surface of said metallic ground plane is parallel to the plane enclosed by said metallic rectangular ring, and said metallic rectangular ring applied to the filter device of the present invention has a perimeter shorter than or equal to the wavelength corresponding to the mean of said odd mode resonant frequency and said even mode resonant frequency, thereby allowing said filter device of the present invention, in a situation of specific bandpass frequency, to reduce its perimeter to about half of the perimeter of conventional annular rectangular dual mode filters. In addition, the locations of the transmission zeros can be changed by adjusting the length/width ratio of said metallic rectangular ring, and the frequency response of the filter signal can also be reduced by disposing a ground capacitor module. Accordingly, the area of the dual mode filter can be greatly reduced. Furthermore, the frequency response of the filter signal can be increased by disposing a ground inductor module, accordingly, decreasing the size of dual mode filter and providing a means of easy fabrication thereof.

### BACKGROUND OF THE INVENTION

1. Field of the Invention

This invention generally relates to a filter device, and more specifically, to a bandpass filter device.

2. Description of Related Art

A bandpass filter is a device that passes frequencies within a certain range and attenuates frequencies outside that range to an extremely low level; namely, an ideal bandpass filter would have a completely flat passband with no gain/attenuation throughout and would completely attenuate all frequencies outside the passband.

In practice, no bandpass filter is ideal in that the filter does not attenuate all frequencies outside the desired frequency range completely. In particular, there is a region just on each side of the intended passband where frequencies are attenuated, but not entirely rejected.

A dual mode filter is a filter design, wherein two coexisting modes of the same ring resonator or disk resonator are coupled with each other. This kind of filter has the characteristics of high Q-factor as well as linear phase and flat group delay. Therefore, this kind of filter has been widely used in satellite applications that demand high performance.

FIG. 1a shows the structures of several conventional dual mode filters. As shown in the figure, a perturbation unit 13 is attached to an otherwise symmetrical surface or symmetrical axes of a ring resonator 11 or square resonator 12 or 12′. Also, an input port 141 and an output port 142 are orthogonal to each other. The perturbation unit 13 is for enabling energy generated by the two modes to couple with each other. In the meantime, the coupling coefficient can be controlled by adjusting the perturbation unit 13 or the angles of the input and output ports.

Since a dual mode filter has a symmetrical structure, the circuit analysis complexity can be simplified by separately applying analytic techniques for the odd mode and even mode. Referring to FIGS. 1b and 1c, FIG. 1b illustrates the equivalent circuit diagram of the odd-mode excitation of the circuit. For the odd-mode excitation, the circuit of FIG. 1a is bisected by grounding it at two points on its midplane. FIG. 1c depicts the equivalent circuit diagram of the even-mode excitation of the circuit. For the even-mode excitation, the circuit of FIG. 1a is bisected with open circuits at two points on its midplane.

In the aforesaid equivalent circuits, Zₗ and Zₚ are impedances of the resonator and the perturbation unit, respectively, while θₗ and θₚ are the electrical lengths of the resonator and the perturbation unit, respectively. Such a dual mode filter is capable of generating both odd mode and even mode signals, wherein both kinds of signals are affected by the aforesaid impedances and the electrical lengths. In other words, the center frequency of such a dual mode filter is determined by the length of the resonator.

In terms of the frequency response of specific signal selectivity, the circuit area of a dual mode filter is notably larger than the circuit area of other kinds of filters, thereby occupying a considerable circuit layout area. Accordingly, it has become a highly urgent issue to designers in the filter industry to devise a way to provide a dual mode filter design corresponding to a frequency response of specific signal selectivity that has a smaller layout area.

### SUMMARY OF THE INVENTION

In view of the disadvantages of the prior art mentioned above, it is a primary objective of the present invention to provide a filter device that is capable of reducing the area and length of the dual mode filter significantly by selecting specific element sizes and applying ground capacitors.

To achieve the aforementioned and other objectives, a filter device provided according to the present invention has odd mode resonant frequency and even mode resonant frequency; the filter device has at least: a substrate; a metallic rectangular ring mounted on a surface of the substrate, wherein the perimeter is shorter than or equal to the wavelength corresponding to the mean of the odd mode resonant frequency and the even mode resonant frequency; a signal couple-in/couple-out module including a signal couple-in portion and a signal couple-out portion mounted on a surface of the substrate; and a metallic ground plane having a metallic surface parallel to the plane enclosed by the metallic rectangular ring.

To achieve the aforementioned and other objectives, another filter device having odd mode resonant frequency and even mode resonant frequency is provided according to the present invention; the filter device consists of at least: a metallic rectangular ring, wherein the perimeter of the metallic rectangular ring is shorter than or equal to the wavelength corresponding to the mean of the odd mode resonant frequency and the even mode resonant frequency; a metallic ground plane that has a metallic surface, wherein the metallic surface is parallel to a plane enclosed by the metallic rectangular ring; and a signal couple-in/couple-out module has a signal couple-in portion and a signal couple-out portion, wherein neither the signal couple-in portion nor the signal couple-out portion are in contact with the metallic rectangular ring, but rather coupling gaps exist between the signal couple-in portion and the metallic rectangular ring as well as between the signal couple-out portion and the metallic rectangular ring.

To achieve the aforementioned and other objectives, a further filter device is provided according to the present invention, which has odd mode resonant frequency and even mode resonant frequency; the filter device includes at least: a metallic rectangular ring, wherein the perimeter of the metallic rectangular ring is shorter than or equal to the wavelength corresponding to the mean of the odd mode resonant frequency and the even mode resonant frequency; a metallic ground plane that has metallic surface, wherein the metallic surface is parallel to a plane enclosed by the metallic rectangular ring; a ground capacitor module, which is connected to the metallic rectangular ring; and a signal couple-in/couple-out module, which consists of a signal couple-in portion and a signal couple-out portion, also neither the signal couple-in portion nor the signal couple-out portion are in contact with the metallic rectangular ring, but rather coupling gaps exist between the signal couple-in portion and the metallic rectangular ring as well as between the signal couple-out portion and the metallic rectangular ring.

In summary, the filter device of the present invention is characterized by applying a metallic rectangular ring, which has a perimeter that is shorter than or equal to the wavelength corresponding to the mean of the odd mode resonant frequency and the even mode resonant frequency, thereby allowing the filter device, in the situation of specific bandpass frequency, to reduce its perimeter to about half of the perimeter of conventional annular rectangular ring filter. In addition, the locations of transmission zeros can be changed by adjusting the length/width ratio of the metallic rectangular ring. Furthermore, the frequency response of the filter signal can be reduced by disposing a ground capacitor module on the metallic rectangular ring; therefore, in the situation of frequencies within a specific passband, the design of the present invention is capable of significantly reducing the area of the dual mode filter.

When the filter has a higher center frequency, meaning the wavelength is shorter, the side length of the metallic rectangular ring will become too short and considerably close to the manufacturable minimum size. A reverse approach in this situation is to add in a ground inductor module by means of grounded open- or short-circuited transmission line stubs to increase side length, thereby providing an easier means of fabricating the metallic rectangular ring.

### BRIEF DESCRIPTION OF DRAWINGS

The present invention can be more fully understood by reading the following detailed description of the preferred embodiments, with reference made to the accompanying drawings, wherein:

FIG. 1a is the structure of a conventional dual mode filters;

FIG. 1b is an equivalent bisected circuit diagram for odd-mode excitation;

FIG. 1c is an equivalent bisected circuit diagram for even-mode excitation;

FIG. 2a is an electrical structure of the first embodiment of the filter device of the present invention;

FIG. 2b is an electrical structure of the filter device, wherein the metal rectangular ring and the signal couple-in/couple-out module are in the same plane;

FIG. 2c is an electrical structure of the filer device, wherein the metal rectangular ring and the signal couple-in/couple-out module are not in the same plane;

FIG. 2d is an odd-mode equivalent circuit of the filter device of the present invention;

FIG. 2e is an even-mode equivalent circuit of the filter device of the present invention;

FIG. 3a is a structure of the second embodiment of the filter device of the present invention;

FIG. 3b is the frequency response of the second embodiment of the filter device of the present invention;

FIG. 3c is the structure of the third embodiment of the filter device of the present invention;

FIG. 3d is the frequency response of the third embodiment of the filter device of the present invention;

FIG. 4a is the structure of the fourth embodiment of the filter device of the present invention;

FIG. 4b is the frequency response of the fourth embodiment of the filter device of the present invention;

FIG. 5a is the structure of the fifth embodiment of the filter device of the present invention;

FIG. 5b is the frequency response of the fifth embodiment of the filter device of the present invention;

FIG. 5c is the structure of the sixth embodiment of the filter device of the present invention; and

FIG. 5d is the frequency response of the sixth embodiment of the filter device of the present invention.

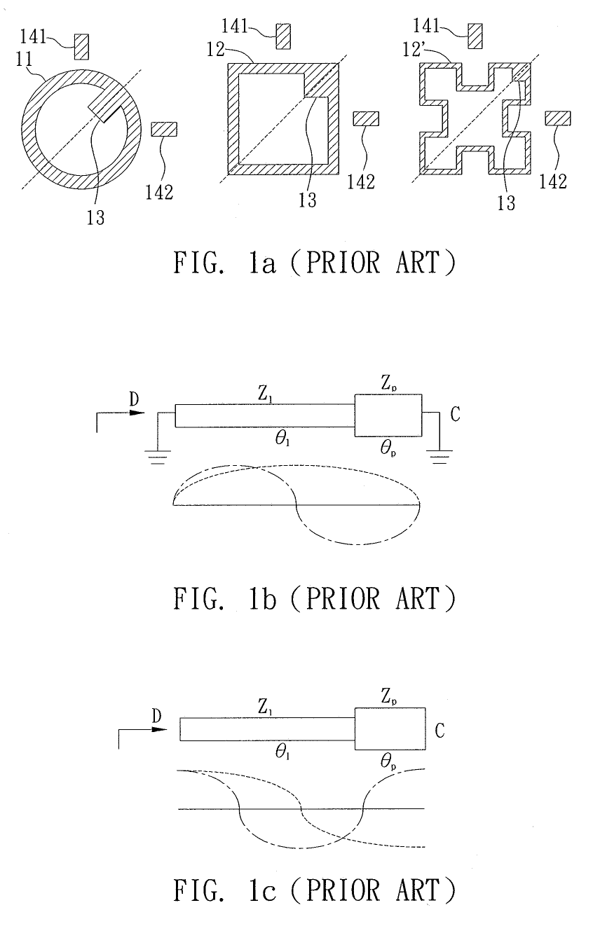

### DETAILED DESCRIPTION OF PREFERRED EMBODIMENTS

The following illustrative embodiments are provided to illustrate the disclosure of the present invention, these and other advantages and effects being readily understood by those in the art after reading the disclosure of this specification. The present invention can also be performed or applied by other differing embodiments. The details of the specification may be changed on the basis of different points and applications, and numerous modifications and variations can be devised without departing from the spirit of the present invention.

### First Embodiment

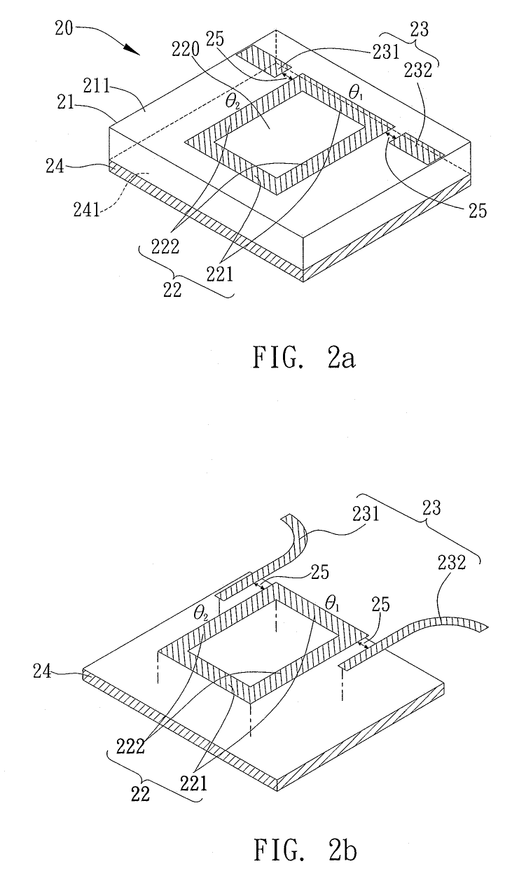

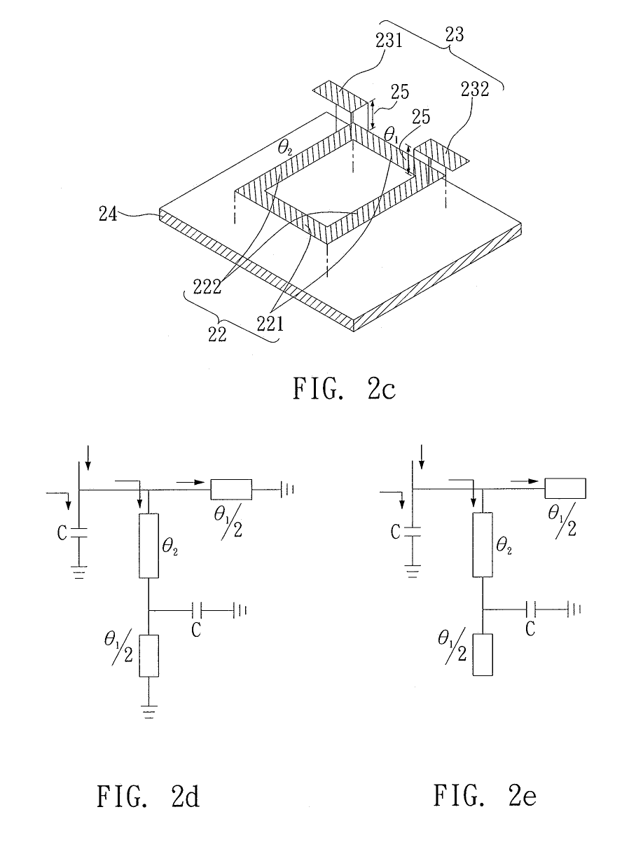

Referring to FIG. 2a, the structure of the first embodiment of the filter device of the present invention is depicted. As shown in the figure, the filter device 20 is driven by odd- and even-mode resonant frequency sources, and the filter device 20 is made up of at least: a substrate 21 including a substrate surface 211; a metallic rectangular ring 22 mounted on the substrate surface 211, wherein the perimeter of the metallic rectangular ring 22 is smaller than or equal to the wavelength corresponding to the mean of the odd mode resonant frequency and the even mode resonant frequency; a signal couple-in/couple-out module 23 including a signal couple-in portion 231 and a signal couple-out portion 232 that are mounted on the substrate surface 211; and a metallic ground plane 24 having a metallic surface 241 parallel to a plane 220 that is enclosed by the metallic rectangular ring. In particular, a microstrip line ring resonator is composed of the metallic rectangular ring 22, the signal couple-in/couple-out module 23, and the metallic ground plane 24.

The substrate 21, the metallic rectangular ring 22, the signal couple-in/couple-out module 23, and the metallic ground plane 24 can be integratedly fabricated through, but not restricted to, the low temperature co-fire ceramic (LTCC) multilayer fabrication process. The low temperature co-fire ceramic (LTCC) multilayer fabrication process is capable of embedding elements, such as filter, equalizer, matching circuit, duplexer, and etc. into a single low temperature co-fire ceramic substrate. Furthermore, since the nature of ceramic material is considerably close to the nature of silicon material, the ceramic material employed is very compatible with the IC chip when bonding with each other, thereby providing advantages of saving space and lowering cost.

Referring now to FIGS. 2b and 2c, FIG. 2b illustrates an electrical structure of the filter device, wherein the metal rectangular ring 22 and the signal couple-in/couple-out module 23 are in/on the same plane, and FIG. 2c depicts an electrical structure of the filer device, wherein the metal rectangular ring 22 and the signal couple-in/couple-out module 23 are not in/on the same plane. As shown in the figures, neither signal couple-in portions 231 nor signal couple-out portions 232 of these two filter devices is in contact with the metallic rectangular rings 22 in either configuration. Rather, coupling gaps 25 exist between the signal couple-in portion 231 and the metallic rectangular ring 22, and, likewise, between the signal couple-out portion 232 and the metallic rectangular ring 22. And since the electric field intensity of an electro-magnetic signal is related to the width of the coupling gaps 25, the coupling area and the coupling angle, the width of the coupling gaps 25, the coupling area and coupling angle will directly affect the passband signal transmission coefficient.

It should be mentioned herein, the perimeter of the metallic rectangular ring 22 can be analhyzed by dividing the metallic rectangular ring 22 into a first pair of opposite sides 221 and a second pair of opposite sides 222, wherein θ₁ is the side length of each of the first pair of opposite sides 221, and θ₂ is the side length of each of the second pair of opposite sides 222.

Further referring to FIGS. 2d and 2e, wherein FIG. 2d is an odd-mode equivalent circuit of the present invention, and FIG. 2e is an even-mode equivalent circuit of the present invention. As shown in the figures, a microstrip line ring resonator is composed of the metallic rectangular ring 22, the signal couple-in/couple-out module 23 and the metallic ground plane 24. Also the signals generated by the microstrip line ring resonator can be analyzed by the dual mode analysis technique, therefore, the microstrip line ring resonator having the metallic rectangular ring 22 can be analyzed by being divided into an odd mode equivalent circuit and an even mode equivalent circuit. The odd mode equivalent circuit is shown in FIG. 2d, and can be analyzed using an equivalent circuit with two grounded ends, while the even mode equivalent circuit is shown in FIG. 2e, and can be analyzed using an equivalent circuit with open-circuits at the two ends. In both cases, capacitance C's indicate the parasitic capacitance generated at the bends.

As shown in FIGS. 2d and 2e, the effective impedance of the equivalent circuit can be changed by adjusting the lengths of the two pairs of sides, and since the wave distribution of the bandpass signal frequency response will be affected by adjusting the effective impedance of the circuit, the transmission zeros on both sides of the passband of the bandpass frequency response will be changed too. In other words, the length/width ratio of the metallic rectangular ring will affect the transmission zeros on both sides of the passband of the passband frequency response as well as the frequency response of whole circuit.

### Second Embodiment

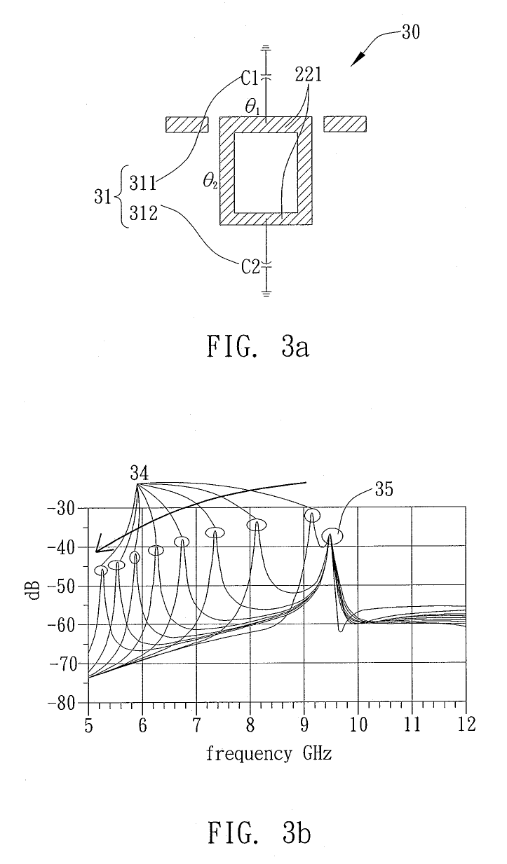

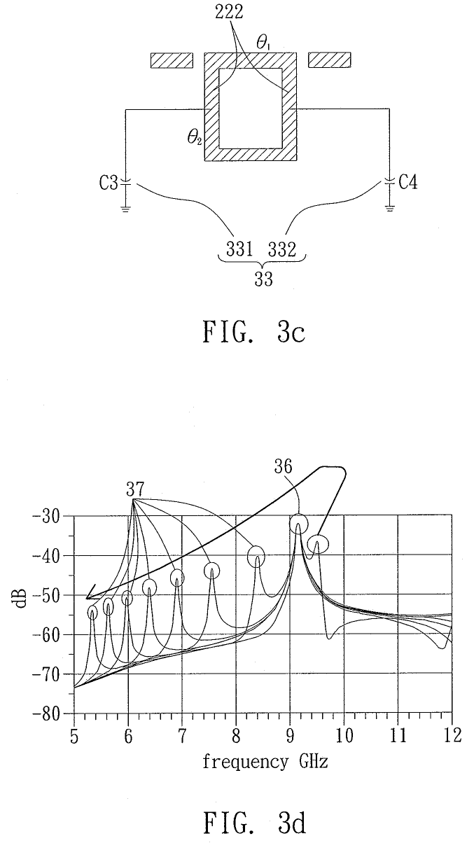

Referring to FIG. 3a, the structure of the second embodiment of the filter device of the present invention is illustrated. The main difference here from that of the first embodiment is that the filter device 30 of the present embodiment further includes a ground capacitor module 31, wherein the ground capacitor module 31 has a first ground capacitor 311 and a second ground capacitor 312, and also the first ground capacitor 311 and the second ground capacitor 312 are electrically connected to middle points of the first pair of opposite sides 221, respectively.

Further referring to FIG. 3b, it illustrates changes happening to the signal frequency response of the filter device of the present invention after the first ground capacitor 311 and the second ground capacitor 312 are electrically connected to the middle points of the first pair of opposite sides 221 of the filter device respectively. In the figure, the first peak 34 corresponds to the even mode resonant frequency, while the second peak 35 corresponds to the odd mode resonant frequency. Also, as shown in the figure, when the capacitance of the first ground capacitor 311 and the capacitance of the second ground capacitor 312 increase, the magnitude of the odd mode resonant frequency response corresponding to the second peak 35 is unchanged, while the magnitude of the even mode resonant frequency response corresponding to the first peak 34 is progressively shifted to low frequency band. In summary, if the middle points of the first pair of opposite sides 221 are connected with the first ground capacitor 311 and the second ground capacitor 312 respectively, the odd mode resonant frequency of the filter signal is not affected while the even mode resonant frequency will be reduced accordingly.

### Third Embodiment

Referring to FIG. 3c, the structure of the third embodiment of the filter device of the present invention is given. The difference here from the first embodiment is that the filter device 32 in the present embodiment is further provided with a ground capacitor module 33, wherein the ground capacitor module 33 includes a third ground capacitor 331 and a fourth ground capacitor 332, allowing the third ground capacitor 331 and the fourth ground capacitor 332 to be electrically connected to the middle points of the second pair of opposite sides 222.

Further referring to FIG. 3d, it illustrates changes happening to the signal frequency response of the filter device of the present invention after the third ground capacitor 331 and the fourth ground capacitor 332 are electrically connected to the middle points of the second pair of opposite sides 222 of the filter device, respectively. It is to be noted that the third peak 36 corresponds to the even mode resonant frequency, while the fourth peak 37 corresponds to the odd mode resonant frequency. Also as shown in the figure, when the capacitance of the third ground capacitor 331 and the capacitance of the fourth ground capacitor 332 increase, the even mode resonant frequency corresponding to the third peak 36 is unchanged, while the odd mode resonant frequency corresponding to the fourth peak 37 is shifted to the low frequency band. In summary, if the middle points of the second pair of opposite sides 222 are connected with the third ground capacitor 331 and the fourth ground capacitor 332, respectively, the even mode resonant frequency of the filter is not affected while the odd mode resonant frequency will be reduced accordingly.

### Fourth Embodiment

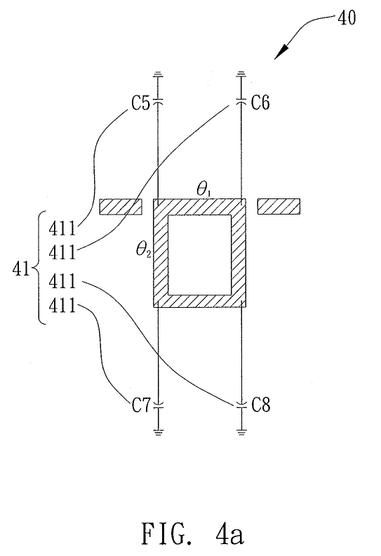

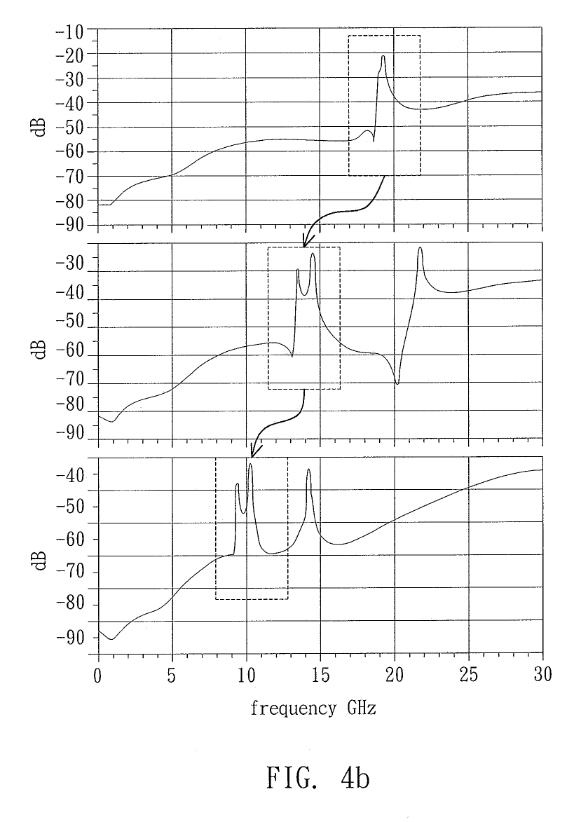

Referring to FIG. 4a, the structure of the fourth embodiment of the filter device of the present invention is illustrated. The difference here from the first embodiment is that the filter device 40 is further provided with a ground capacitor module 41, wherein the ground capacitor module 41 includes four ground capacitors 411 that are electrically connected to the four corners of the metallic rectangular ring 22, respectively.

Further referring to FIG. 4b, it illustrates changes happening to the signal frequency response of the filter device of the present invention after the ground capacitors 411 are electrically connected to the four corners of the metallic rectangular ring 22 of the filter device, respectively. As shown in the figure, the entire frequency response of filter signal is lowered significantly by adding these four ground capacitors 411. Also, when the capacitances of the four ground capacitors 411 increase(s), the overall frequency response of the filter signal decreases, correspondingly. In that connecting the four ground capacitors 411 will decrease the overall signal frequency response of the filter signal generated by the device of the present invention, therefore in the condition of fixed signal frequency response, the overall area of the filter device of the present invention can be reduced greatly.

### Fifth Embodiment

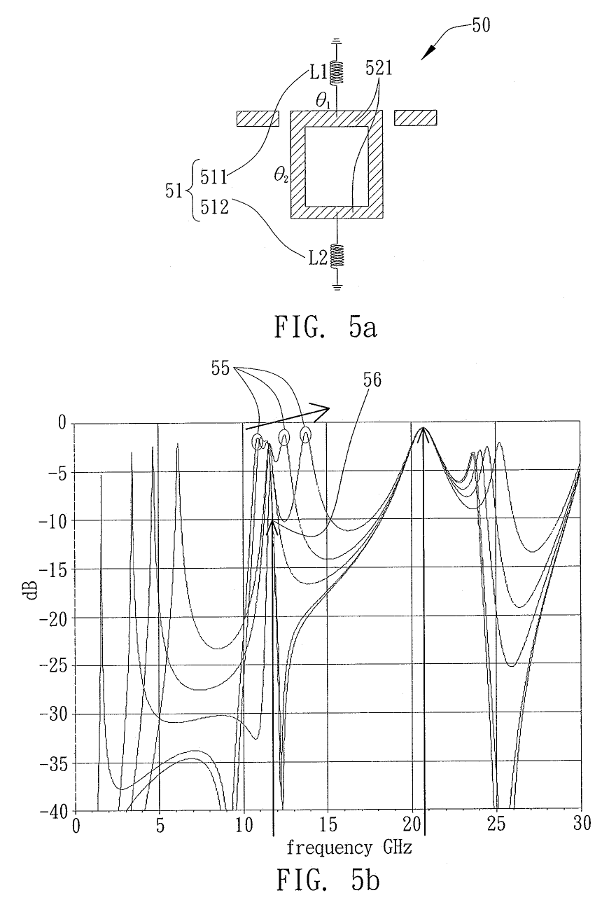

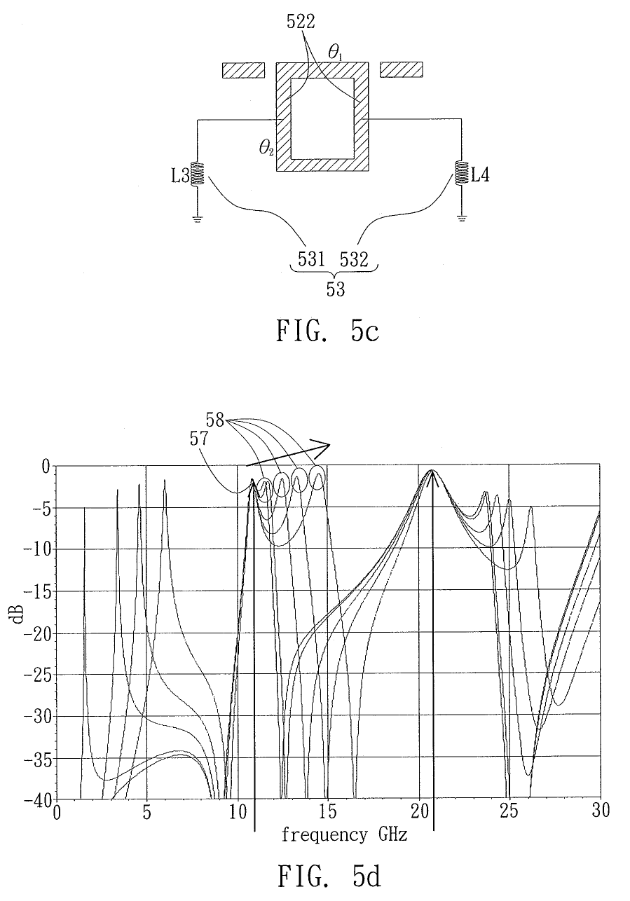

Referring to FIG. 5a, the structure of the fifth embodiment of the filter device of the present invention is illustrated. The difference here from the first embodiment is that the filter device 50 of the present embodiment is further provided with a ground inductor module 51. The ground inductor module 51 has a first ground inductor 511 and a second ground inductor 512, allowing the first ground inductor 511 and the second ground inductor 512 to be electrically connected to the middle points of a first pair of opposite sides 521.

Referring now to FIG. 5b, it illustrates changes happening to the frequency response of the filter device of the present invention after the first ground inductor 511 and the second ground inductor 512 are electrically connected to the middle points of the first pair of opposite sides 521 of the filter device, respectively. It is to be noted that the fifth peak 55 corresponds to the even mode resonant frequency, while the sixth peak 56 corresponds to the odd mode resonant frequency.

As shown in FIG. 5b, when the inductances of the first ground inductor 511 and the second ground inductor 512 decrease, the odd mode resonant frequency corresponding to the sixth peak 56 is unchanged, while the even mode resonant frequency corresponding to the fifth peak 55 in the 10-15 GHz range increases, wherein the fifth peak 55 is shifted to high frequency band. In summary, if the middle points of the first pair of opposite sides 521 are connected with the first ground inductor 511 and the second ground inductor 512, respectively, the odd mode resonant frequency of the filter signal is not affected while the frequency response of the even mode resonant signal in the 10-15 GHz range will be shifted to the high frequency band as the inductance changes.

### Sixth Embodiment

Referring to FIG. 5c, the structure of the sixth embodiment of the filter device of the present invention is shown. The difference here from the first embodiment is that the filter device 52 of the present embodiment further consists of a ground inductor module 53, wherein ground inductor module 53 includes a third ground inductor 531 and a fourth ground inductor 532. Also, the third ground inductor 531 and the fourth ground inductor 532 are electrically connected to the middle points of a second pair of opposite sides 522.

Referring now to FIG. 5d, it illustrates changes happening to the frequency response of the filter device of the present invention after the third ground inductor 531 and the fourth ground inductor 532 are electrically connected to the middle points of the second pair of opposite sides 522 of the filter device, respectively. It is to be noted that the seventh peak 57 corresponds to the even mode resonant frequency, while the eighth peak 58 corresponds to the odd mode resonant frequency.

As shown in FIG. 5d, when the inductance of the third ground inductor 531 and the inductance of the fourth ground inductor 532 decrease, the magnitude of the even mode resonant frequency response corresponding to the seventh peak 57 is unchanged, while the magnitude of the odd mode resonant frequency response corresponding to the eighth peak 58 is shifted to the higher frequency band. In summary, if the middle points of the second pair of opposite sides 522 are connected with the third ground inductor 531 and the fourth ground inductor 532, respectively, the even mode resonant frequency of the filter is not affected while the frequency response of the odd mode resonant frequency will be shifted to the higher frequency band accordingly as the inductance changes.

According to the disclosed techniques of the fifth and the sixth embodiments, when the filter has a higher center frequency, the wavelength is shorter, thereby causing the side length to become too short and considerably close to the manufacturable minimum size. A reverse approach in this situation is to add a ground inductor module by means of grounded open- or short-circuited transmission line stubs to increase the side length, thereby providing an easier means of fabricating the metallic rectangular ring.

In summary, the filter device of the present invention is characterized by applying a metallic rectangular ring, which has a perimeter that is shorter than or equal to the wavelength corresponding to the mean of the odd mode resonant frequency and the even mode resonant frequency, thereby allowing the filter device, in the situation of a specific bandpass frequency, to reduce its perimeter to about half the perimeter of the conventional annular rectangular ring filter. In addition, the frequency response of the filter signal can be reduced by adjusting the length/width ratio of the metallic rectangular ring, or even by coupling a ground capacitor module to the metallic rectangular ring. Therefore, in the situation of a specific bandpass frequency, the design of the present invention is capable of reducing the area of the dual mode filter greatly.

The foregoing descriptions of the detailed embodiments are only illustrated to disclose the features and functions of the present invention and are not restrictive of the scope of the present invention. It should be understood by those in the art that various modifications and variations can be made according to the spirit and principles in the disclosure of the present invention and yet still fall within the scope of the appended claims.

What is claimed is:

1. A filter device with finite transmission zeros and having an odd mode resonant frequency and an even mode resonant frequency, said filter device comprising at least:
a substrate having a surface;
a metallic rectangular ring mounted on said surface of said substrate and having a perimeter not greater than a wavelength corresponding to a mean of said odd mode resonant frequency and said even mode resonant frequency; and
a signal couple-in/couple-out module arranged on said surface of said substrate and comprising a signal couple-in portion and a signal couple-out portion.

2. The filter device of claim 1, further comprising a metallic ground plane having a metallic surface parallel to a plane enclosed by said metallic rectangular ring.

3. The filter device of claim 2, wherein said metallic rectangular ring, said signal couple-in/couple-out module, and said metallic ground plane are formed into a microstrip line ring resonator.

4. The filter device of claim 2, wherein said substrate, said metallic rectangular ring, said signal couple-in/couple-out module, and said metallic ground plane are integrated by a low temperature co-fire ceramic (LTCC) multilayer fabrication process.

5. The filter device of claim 1, wherein said signal couple-in portion and said signal couple-out portion are free from being in contact with said metallic rectangular ring.

6. The filter device of claim 1, wherein coupling gaps exist between said signal couple-in portion and said metallic rectangular ring as well as between said signal couple-out portion and said metallic rectangular ring.

7. The filter device of claim 1, wherein said perimeter of said metallic rectangular ring includes a first pair of opposite sides and a second pair of opposite sides.

8. The filter device of claim 7, wherein the ratio of the length of said first pair of opposite sides to the length of said second pair of opposite sides of said metallic rectangular ring is used to determine the transmission zeros on both sides of said passband signal and the bandwidth of said passband signal.

9. A filter device with transmission zeros having an odd mode resonant frequency and an even mode resonant frequency, said filter device comprising at least:
a metallic rectangular ring, wherein the perimeter of said metallic rectangular ring is shorter than or equal to the wavelength corresponding to the mean of said odd mode resonant frequency and said even mode resonant frequency; and
a signal couple-in/couple-out module comprising a signal couple-in portion and a signal couple-out module, wherein neither said signal couple-in portion nor said signal couple-out portion are in contact with said metallic rectangular ring, but rather coupling gaps exist between said signal couple-in portion and said metallic rectangular ring as well as between said signal couple-out portion and said metallic rectangular ring.

10. The filter device of claim 9, further comprising a metallic ground plane that has a metallic surface, parallel to the plane enclosed by said metallic rectangular ring.

11. The filter device of claim 10, wherein a microstrip line ring resonator is composed of said metallic rectangular ring, said signal couple-in/couple-out module, and said metallic ground plane.

12. The filter device of claim 10, wherein said metallic rectangular ring, said signal couple-in/couple-out module, and said metallic ground plane are integrated by a low temperature co-fire ceramic (LTCC) multilayer fabrication process.

13. The filter device of claim 9, wherein said perimeter of said metallic rectangular ring comprises a first pair of opposite sides and a second pair of opposite sides.

14. The filter device of claim 13, wherein transmission zeros on both sides of the passband signal and bandwidth of said passband signal are affected by the ratio of the length of said first pair of opposite sides to the length of said second pair of opposite sides of said metallic rectangular ring.

15. A filter device with transmission zeros having an odd mode resonant frequency and an even mode resonant frequency comprises at least:
a metallic rectangular ring, having a perimeter shorter than or equal to a wavelength corresponding to the mean of said odd mode resonant frequency and said even mode resonant frequency;
a ground capacitor module connected to said metallic rectangular ring; and
a signal couple-in/couple-out module comprising a signal couple-in portion and a signal couple-out module, wherein neither said signal couple-in portion nor said signal couple-out portion are in contact with said metallic rectangular ring, but rather coupling gaps exist between said signal couple-in portion and said metallic rectangular ring as well as between said signal couple-out portion and said metallic rectangular ring.

16. The filter device of claim 15, further comprising a metallic ground plane having a metallic surface parallel to the plane enclosed by said metallic rectangular ring.

17. The filter device of claim 16, wherein a microstrip line ring resonator is formed by said metallic rectangular ring, said signal couple-in/couple-out module, and said metallic ground plane.

18. The filter device of claim 16, wherein said metallic rectangular ring, said signal couple-in/couple-out module, and said metallic ground plane are integrated by a low temperature co-fire ceramic (LTCC) multilayer fabrication process.

19. The filter device of claim 15, wherein said perimeter of said metallic rectangular ring comprises a first pair of opposite sides and a second pair of opposite sides.

20. The filter device of claim 19, wherein the transmission zeros on both sides of the passband signal and the bandwidth of said passband signal are affected by the ratio of the length of said first pair of opposite sides to the length of said second pair of opposite sides of said metallic rectangular ring.

21. The filter device of claim 15, wherein said ground capacitor module comprises four ground capacitors electrically connected to the four corners of said metallic rectangular ring, respectively.

22. The filter device of claim 15, wherein said ground capacitor module comprises two ground capacitors electrically connected to the middle points of said first pair of opposite sides of said metallic rectangular ring.

23. The filter device of claim 15, wherein said ground capacitor module comprises two ground capacitors electrically connected to the middle points of said second pair of opposite sides of said metallic rectangular ring.

24. A filter device with transmission zeros having an odd mode resonant frequency and an even mode resonant frequency, comprising at least:
a metallic rectangular ring, wherein the perimeter of said metallic rectangular ring is shorter than or equal to the wavelength corresponding to the mean of said odd mode resonant frequency and said even mode resonant frequency;
a ground inductor module connected to said metallic rectangular ring; and
a signal couple-in/couple-out module comprising a signal couple-in portion and a signal couple-out module, wherein neither said signal couple-in portion nor said signal couple-out portion are in contact with said metallic rectangular ring but rather coupling gaps exist between said signal couple-in portion and said metallic rectangular ring as well as between said signal couple-out portion and said metallic rectangular ring.

25. The filter device of claim 24, wherein said filter device further comprises a metallic ground plane having a metallic surface parallel to the plane enclosed by said metallic rectangular ring.

26. The filter device of claim 25, wherein a microstrip line ring resonator is formed by said metallic rectangular ring, said signal couple-in/couple-out module, and said metallic ground plane.

27. The filter device of claim 25, wherein said metallic rectangular ring, said signal couple-in/couple-out module, and said metallic ground plane are integrated by a low temperature co-fire ceramic (LTCC) multilayer fabrication process.

28. The filter device of claim 24, wherein said perimeter of said metallic rectangular ring comprises a first pair of opposite sides and a second pair of opposite sides.

29. The filter device of claim 28, wherein transmission zeros on both sides of the passband signal, and bandwidth of said passband signal are affected by the ratio of the length of said first pair of opposite sides to the length of said second pair of opposite sides of said metallic rectangular ring.

30. The filter device of claim 24, wherein said ground inductor module comprises two ground inductors connected to the middle points of said first pair of opposite sides of said metallic rectangular ring, respectively.

31. The filter device of claim 24, wherein said ground inductor module comprises two ground inductors connected to the middle points of said second pair of opposite sides of said metallic rectangular ring, respectively.
